(19) United States
(12) Patent Application Publication
(10) Pub. No.: US 2026/0135189 A1
(43) Pub. Date: May 14, 2026

(54) BATTERY HOUSING

(71) Applicants: HYUNDAI MOTOR COMPANY, Seoul (KR); KIA CORPORATION, Seoul (KR)

(72) Inventors: Jong Gyu Park, Hwaseong-si (KR); Kyung Mo Kim, Hwaseong-si (KR); Gun Woo Ko, Hwaseong-si (KR); Chan Sol Kim, Hwaseong-si (KR)

(73) Assignees: HYUNDAI MOTOR COMPANY, Seoul (KR); KIA CORPORATION, Seoul (KR)

(21) Appl. No.: 19/213,716

(22) Filed: May 20, 2025

(30) Foreign Application Priority Data
Aug. 19, 2024 (KR) 10-2024-0110816

(51) Int. Cl. H01M 10/6567; B60L 50/64; H01M 10/613; H01M 10/625; H01M 10/647; H01M 50/103; H01M 50/15

(52) U.S. Cl. CPC H01M 10/6567; H01M 10/613; H01M 10/625; H01M 10/647; H01M 50/103; H01M 50/15; B60L 50/64; H01M 2220/20

(57) ABSTRACT

Disclosed is a battery housing including a base plate, a side member disposed on one side of the base plate in a first direction, a cooling water channel disposed on an inner side of the side member in the first direction, and including a manifold pipe extending in a second direction crossing the first direction, and a cover module covering an inner side of the manifold pipe, and extending in the second direction to accommodate the manifold pipe together with the side member. The cover module includes a support member supporting the manifold pipe.

### CROSS-REFERENCE TO RELATED APPLICATION

This application claims the benefit of and priority to Korean Patent Application No. 10-2024-0110816, filed in the Korean Intellectual Property Office on Aug. 19, 2024, the entire contents of which are incorporated herein by reference.

### TECHNICAL FIELD

The present disclosure relates to a battery housing.

### BACKGROUND

Recently, growing awareness of environmental issues and the depletion of petroleum resources has brought increased attention to the research and development on electric vehicles, which are eco-friendly vehicles. The electric vehicles include plug-in hybrid electric vehicles (PHEVs), battery electric vehicle (BEVs), and fuel cell electric vehicles (FCEVs).

An electric vehicle may include a battery housing that supports battery cells. Meanwhile, an electric vehicle uses battery cells as a power source, and a cooling water channel may be provided in an interior of a battery housing to prevent a temperature of the battery cells from rising.

Meanwhile, when an impact is applied to an electric vehicle, a fire may occur in the battery cells when cooling water discharged from a cooling water channel contacts the battery cells. To prevent a fire from occurring like this, a need for a structure that prevents the cooling water discharged from the cooling water channel from contacting the battery cells is increasing.

The statements in this section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a battery housing for preventing cooling water discharged from a cooling water channel from coming into contact with a battery cell.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a battery housing includes: a base plate; a side member disposed on a side of the base plate in a first direction; a cooling water channel disposed on an inner side of the side member in the first direction and including a manifold pipe extending in a second direction crossing the first direction; and a cover module covering an inner side of the manifold pipe and extending in the second direction to accommodate the manifold pipe together with the side member. In particular, the cover module includes a support member supporting the manifold pipe.

The cover module may include: a partition member covering the inner side of the manifold pipe in the first direction, and a cover member disposed on a side of the support member in a third direction crossing the first direction and the second direction. In particular, the cover member includes a collection space extending in the second direction on a side facing the support member.

The support member may include a communication hole extending in the third direction to be communicated with the collection space.

The support member may include a cover recess formed on a side surface of the support member, which faces the cover member, and the cover member may include a pair of insertion ribs protruding toward the cover recess and spaced apart from each other in the first direction to define the collection space therebetween.

One end of the communication hole, which is communicated with the cover recess, may be disposed between the pair of insertion ribs.

The pair of insertion ribs may extend in the second direction.

the partition member includes: a plurality of fixing slots formed on the inner side of the manifold pipe in the first direction and configured to extend in the third direction; and a plurality of partition plates spaced apart from each other in the second direction. In an embodiment, fixing slots of the plurality of fixing slots are respectively interposed between the plurality of partition plates.

The partition member may include: a fixing hole formed on the inner side of the manifold pipe in the first direction; and a plurality of partition plates spaced apart from each other in the second direction with the fixing hole interposed therebetween.

The partition member may further include a pipe cover part extending to surround an opposite side of the manifold pipe in the third direction from the plurality of partition plates to contact the side member.

The pipe cover part may include: a first part extending from the plurality of partition plates toward the side member; and a second part extending from the first part in the third direction to contact the side member.

The cooling water channel may include a branch pipe connected to the manifold pipe, and inserted into the fixing hole.

The manifold pipe may include a pipe body extending in the second direction, and that allow cooling water to flow in an interior thereof, and a guide part connecting the pipe body and the branch pipe.

The support member may include: a communication hole extending in the third direction to be communicated with the collection space, and a flow space configured to communicate with the communication hole and formed to be recessed on one side of the support member, which faces the partition member. and the flow space extends in the second direction.

The manifold pipe further may include a protrusion protruding from the pipe body and spaced apart from the guide part in the second direction, and the support member may include a seating recess recessed to receive the protrusion.

The cover member may include: a first injection hole through which a material is injected to fill a space between the support member, the partition member, and the manifold pipe.

The cover member may further include a second injection hole formed on a side of the collection space opposite to the first injection hole, and configured to discharge the material injected through the first injection hole.

The support member may include an injection space formed in an area corresponding to a position of the first injection hole.

The battery housing may further include a cooling water discharge pipe configured to communicate with the collection space, and including a first end inserted into the cover member and a second end passing through the side member.

The cover member may further include a discharge pipe support part supporting the first end of the cooling water discharge pipe.

The support member may include a cover recess formed on a side surface of the support member, which faces the cover member, and the cover member may include a pair of insertion ribs protruding toward the cover recess and spaced apart from each other in the first direction to define the collection space therebetween. An end of the insertion rib in the second direction and an end of the cover member in the second direction may be spaced apart from each other in the second direction, and the discharge pipe support part may be formed to connect the end of the insertion rib and the end of the support member.

### BRIEF DESCRIPTION OF THE DRAWINGS

The above and other objects, features and advantages of the present disclosure should be more apparent from the following detailed description taken in conjunction with the accompanying drawings:

FIG. 1 is a perspective view of some components of a battery pack according to an embodiment of the present disclosure;

FIG. 2 is a plan view of components of a battery housing except for a cooling water channel according to an embodiment of the present disclosure;

FIG. 3 is a plan view of a cooling water channel according to an embodiment of the present disclosure;

FIG. 4 is a perspective view of a cover module according to an embodiment of the present disclosure;

FIG. 5 is a perspective view of portions of a partition member, a support member, and a cover member according to an embodiment of the present disclosure;

FIG. 6 is a bottom perspective view of a cover member according to an embodiment of the present disclosure;

FIG. 7 is a bottom perspective view of portions of a cooling water channel and a support member according to an embodiment of the present disclosure;

FIG. 8 is a view of a cover module and a cooling water channel according to an embodiment of the present disclosure;

FIG. 9 is a schematic view of a manifold pipe, with a portion thereof being omitted, and peripheral components according to an embodiment of the present disclosure;

FIG. 10 is a cross-sectional view of a battery housing according to an embodiment of the present disclosure; and

FIG. 11 is a cross-sectional view of a battery housing according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof has been omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

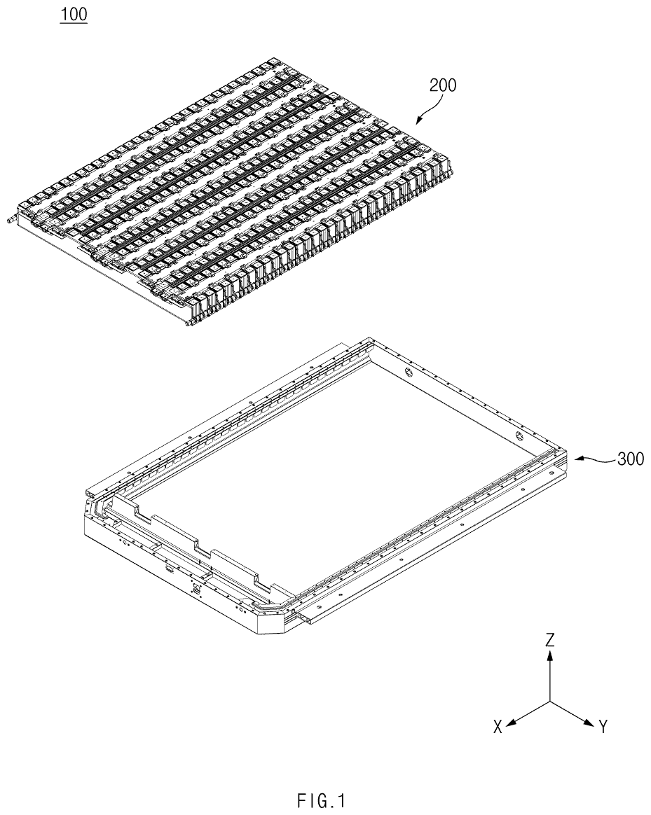

Hereinafter, embodiments of the present disclosure are described in detail with reference to FIGS. 1 to 11. Hereinafter, a leftward/rightward direction may be a first direction, a forward/rearward direction may be a second direction, and an upward/downward vertical direction may be a third direction.

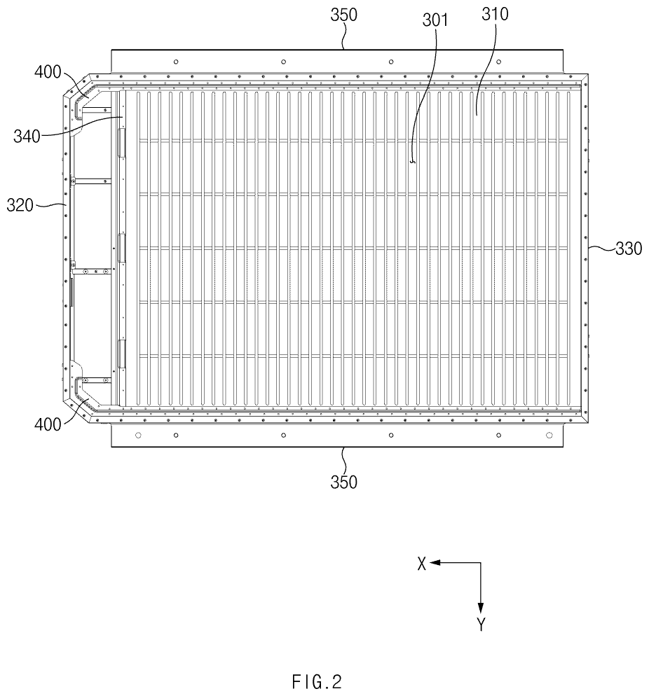

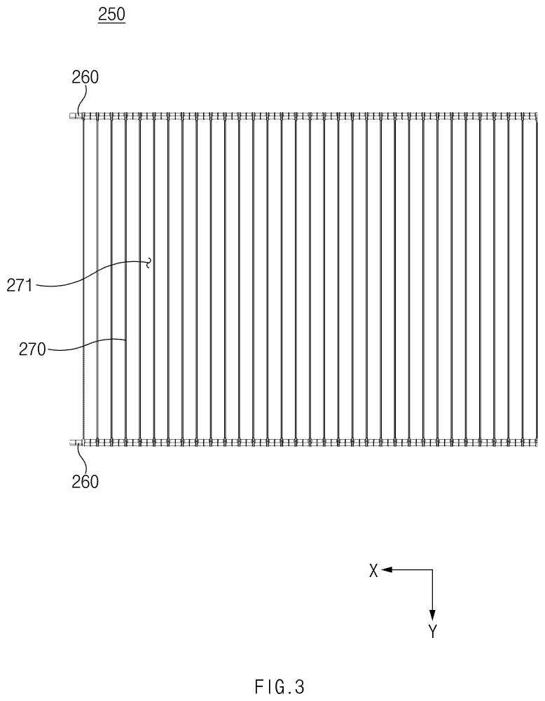

FIG. 1 is a perspective view of some components of a battery pack according to an embodiment of the present disclosure. FIG. 2 is a plan view of components of a battery housing except for a cooling water channel according to an embodiment of the present disclosure. FIG. 3 is a plan view of a cooling water channel according to an embodiment of the present disclosure.

Referring to FIGS. 1 to 3, a battery pack 100 may include battery cells 200 and a battery housing 300 that supports the battery cell 200. The battery cell 200 may be a prismatic or cylindrical battery. The battery cell 200 may be a lithium ion battery, but is not limited thereto.

The battery pack 100 may be mounted with being inverted in the upward/downward direction when being mounted on an electric vehicle. Hereinafter, a direction is described with reference to a case, in which the battery pack 100 is mounted on the electric vehicle.

The battery housing 300 may define a cell accommodation space 301, in which the battery cells 200 are accommodated. The battery housing 300 may include a base plate 310 that covering an area of the battery cell 200 in an upward direction (a direction that is opposite to the “Z” direction). The base plate 310 may support the battery cell 200 when the battery pack 100 is manufactured, but may cover an upper side of the battery cells 200 when the battery pack 100 is mounted on the electric vehicle.

The battery housing 300 may include a front member 320 that covers an area of the cell accommodation space 301 in a forward direction (the “X” direction), and a rear member 330 that covers an area of the cell accommodation space 301 in a rearward direction (an opposite direction to the “X” direction). The battery housing 300 may include a cross member 340 that is disposed between the front member 320 and the rear member 330 and is disposed to face the rear member 330 with the cell accommodation space 301 interposed therebetween. In other words, the cross member 340 is disposed between the front member 320 and the rear member 330, and is positioned to face the rear member 330 across the cell accommodation space 301.

The front member 320, the rear member 330, and the cross member 340 may extend in the leftward/rightward direction (the “Y” direction or an opposite direction to the “Y” direction) and may be coupled to the base plate 310.

The battery housing 300 may include side members 350 that are disposed on opposite sides of the base plate 310 in the leftward/rightward direction. The side members 350 may be provided in a pair to cover an area of the cell accommodation space 301 in a rightward direction (the “Y” direction) and an area in a leftward direction (an opposite direction to the “Y” direction), respectively.

The battery housing 300 may include a cooling water channel 250 for cooling water that is provided to cool the battery cell 200.

The cooling water channel 250 may include a manifold pipe 260, and a branch pipe 270 that is branched from the manifold pipe 260. The manifold pipe 260 may extend in the forward/rearward direction, and the branch pipe 270 may be connected to the manifold pipe 260 to extend in the leftward/rightward direction.

The manifold pipe 260 may be connected to an introduction pipe (not illustrated) for introducing the cooling water into the battery housing 300, and a plurality of branch pipes 270 may be connected to the manifold pipe 260.

The cooling water may be introduced into any one of the pair of manifold pipes 260 through the introduction pipe, and then may flow from the manifold pipe 260 to the branch pipe 270. The cooling water introduced into the branch pipe 270 may flow to the other one of the pair of manifold pipes 260.

The manifold pipe 260 may be disposed on an inner side of the side member 350 in the leftward/rightward direction. A plurality of branch pipes 270 may be provided to branch from the manifold pipe 260 and be spaced apart from each other in forward/rearward direction. A branch space 271 for disposing the battery cells 200 may be formed between the plurality of branch pipes 270, and the plurality of battery cells 200 may be spaced apart from each other with the branch pipes 270 interposed therebetween. In other words, the branch pipes 270 may be interposed between the plurality of battery cells 200, which are spaced apart from one another.

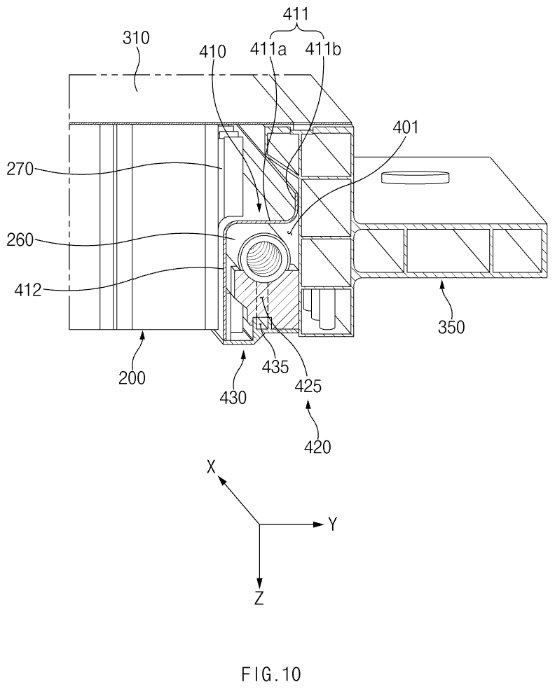

The battery housing 300 may include a cover module 400 that covers an inner side of the manifold pipe 260 of the cooling water channel 250 in the leftward/rightward direction. The cover module 400 may define a pipe accommodation space 401 (see FIG. 10) for accommodating the manifold pipe 260 together with the side member 350. The pipe accommodation space 401 may extend in the forward/rearward direction to accommodate the manifold pipe 260.

The cover module 400 may be formed on the inner side of each of the side members 350 in the leftward/rightward direction to protect the manifold pipe 260, and may be a module for preventing the cooling water that is discharged from the manifold pipe 260 from coming into contact with the battery cells 200.

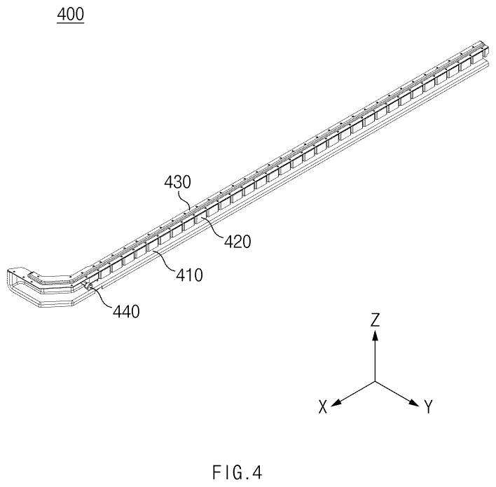

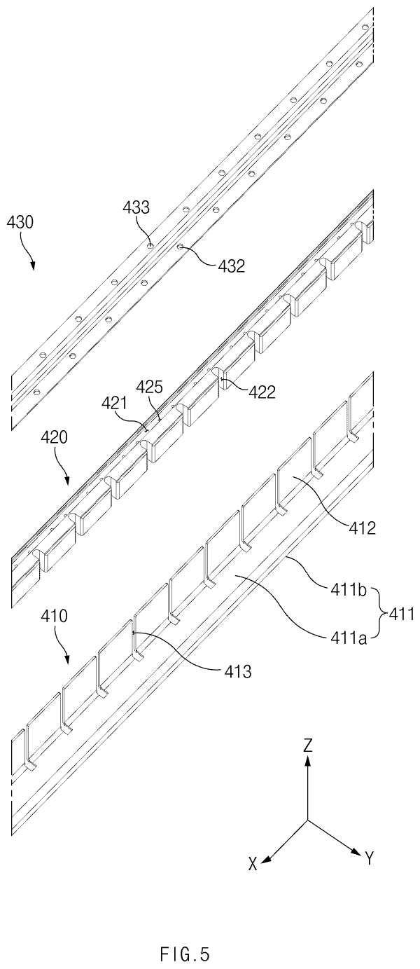

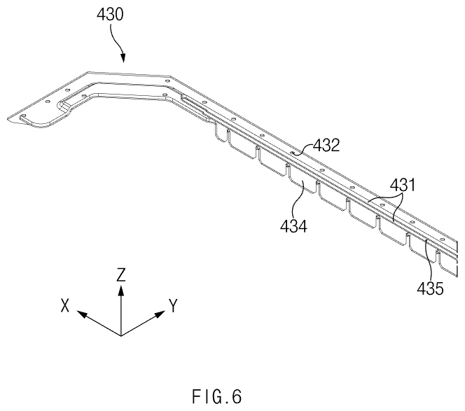

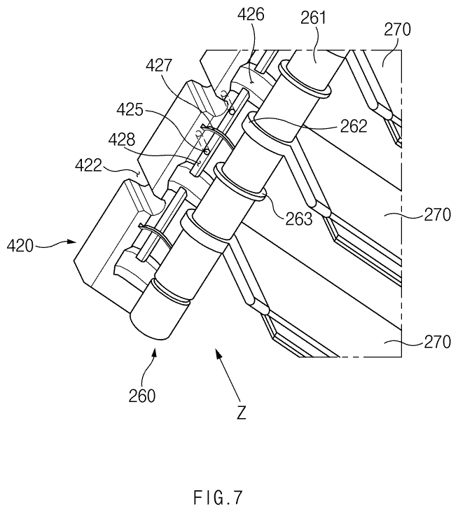

FIG. 4 is a perspective view of a cover module according to an embodiment of the present disclosure. FIG. 5 is a perspective view of portions of a partition member, a support member, and a cover member according to an embodiment of the present disclosure. FIG. 6 is a bottom perspective view of a cover member according to an embodiment of the present disclosure. FIG. 7 is a bottom perspective view of portions of a cooling water channel and a support member according to an embodiment of the present disclosure.

Referring to FIGS. 4 to 7, the cover module 400 may include a partition member 410 that is disposed on a lower side (the “Z” direction) of the base plate 310 (see FIG. 2), a support member 420 that is provided between the partition member 410 and the side member 350, and a cover member 430 disposed on a lower side (the “Z” direction) of the support member 420.

The partition member 410 may cover an inner side of the manifold pipe 260 (see FIG. 10) in the leftward/rightward direction. The support member 420 may support the manifold pipe 260 between the partition member 410 and the side member 350. In other words, the manifold pipe 260 may be mounted between the partition member 410 and the support member 420. The cover member 430 may be disposed on a lower side of the support member 420 to cover the lower side of the support member 420.

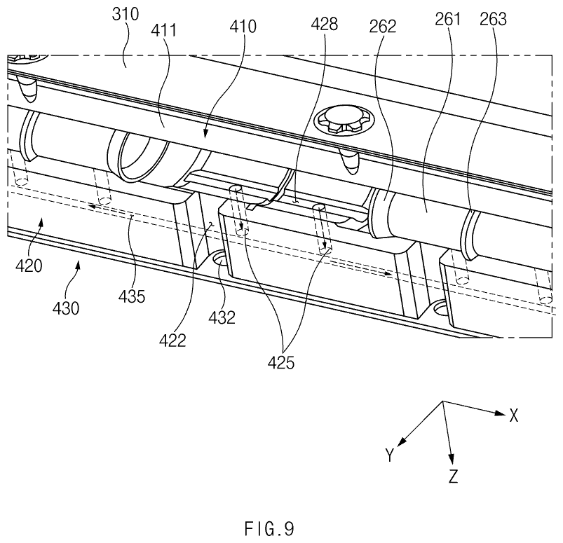

The partition member 410 may be formed of aluminum (AL) to enable welding or mechanical coupling to the base plate 310 (see FIGS. 9-10). However, the material of the partition member 410 is not limited thereto.

The support member 420 may be formed of ethylene propylene rubber (EPDM) to alleviate an external impact that may be applied to the manifold pipe 260 and to insulate the manifold pipe 260 from an external environment. However, the material of the support member 420 is not limited thereto.

The cover member 430 may be formed of plastic. This may be to relatively reduce a weight of the cover member 430. However, the material of the cover member 430 is not limited thereto.

The partition member 410 may cover an upper area of the manifold pipe 260, and the cover member 430 may cover a lower area of the support member 420. The partition member 410 and the cover member 430 may include a portion that is disposed on a front side and faces an inner side in the leftward/rightward direction. This configuration may serve to cover a portion of the introduction pipe, where the partition member 410 and the cover member 430 are connected to the manifold pipe 260. The manifold pipe 260 is inserted into an interior of the battery housing 300 in such a manner that it is separated from the battery cell 200 (see FIG. 1).

In an embodiment, the support member 420 and the cover member 430 may be formed to extend in forward/rearward direction from a lower side of the pipe accommodation space 401 (see FIG. 10), and may define a collection space 435 that is communicated with the pipe accommodation space 401. In other words, the cover member 430 may include a collection space 435 for collecting the cooling water that is discharged from the manifold pipe 260. The collection space 435 may be formed on one side that faces the support member 420 of the cover member 430, and may extend in forward/rearward direction.

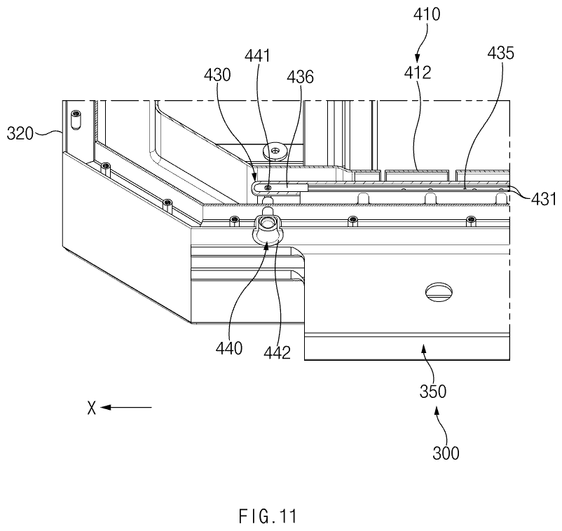

The cover module 400 may include a cooling water discharge pipe 440 that is formed on one side of the collection space 435 to discharge the cooling water collected through the collection space 435 to the outside of the battery housing 300. To this end, the cooling water discharge pipe 440 may be communicated with the collection space 435 to pass through the side member 350 (see FIG. 11).

Referring to FIGS. 10-11, the partition member 410 may include a pipe cover part 411 that is disposed on an upper side of the pipe accommodation space 401 to cover the upper side of the manifold pipe 260, and a partition plate 412 that extends downward from an inner end of the pipe cover part 411.

The pipe cover part 411 may extend from the partition plate 412 to surround an upper side of the manifold pipe 260, and may contact the side member 350.

The pipe cover part 411 may include a first part 411a that extends from the partition plate 412 toward the side member 350, and a second part 411b that extends downward from the first part 411a to contact the side member 350.

A plurality of partition plates 412 may be provided to be spaced apart from each other in forward/rearward directions, and fixing holes which may be round or shaped through-holes. For example, the fixing holes may be formed as fixing slots 413 that extend in the upward/downward direction. The fixing holes (e.g., the fixing slots) may be formed between the plurality of partition plates 412. A branch pipe 270 may be inserted into the fixing slot 413.

Contact between the manifold pipe 260 and the battery cells 200 (see FIG. 1) may be prevented by the structure of the partition plate 412.

The fixing slot 413 may be formed on an inner side of the manifold pipe 260 in the leftward/rightward direction, and may extend in the upward/downward direction, and a lower side thereof may be opened. A plurality of partition plates 412 may be spaced apart from each other in the forward/rearward direction with the fixing slots 413 interposed therebetween. The partition plate 412 may protect an inner side of the manifold pipe 260 in the leftward/rightward direction.

The support member 420 may support the manifold pipe 260 while surrounding the manifold pipe 260 together with the partition member 410. The cover member 430 may be disposed on an opposite side to one side of the support member 420, which faces the partition member 410. The support member 420 may define a collection space 435 together with the cover member 430.

The support member 420 may include a cover recess 421 that is formed on one side surface that faces the cover member 430. The cover recess 421 may extend in the forward/rearward direction. The support member 420 may include an injection space 422 that is formed in an area that is disposed on an outer side of the cover recess 421 in the leftward/rightward direction and extends in the upward/downward direction.

The support member 420 may include a communication hole 425 that extends in the upward/downward direction to pass through the support member 420. The communication hole 425 may be formed on a lower side of the pipe accommodation space 401, and may be provided to be spaced apart from each other in the forward/rearward direction along the cover recess 421. The communication hole 425 may be a hole, through which the cooling water discharged from the manifold pipe 260 is collected into the collection space 435. The communication hole 425 may extend in the upward/downward direction to be communicated with the collection space 435.

The cover member 430 may include a pair of insertion ribs 431 that protrude toward the cover recess 421 and are spaced apart from each other in the leftward/rightward direction. The pair of insertion ribs 431 may be inserted into the cover recess 421. A collection space 435 may be formed between the pair of insertion ribs 431. Furthermore, one end of the communication hole 425, which is communicated with the cover recess 421, may be disposed between the pair of insertion ribs 431.

A lower side and opposite sides of the collection space 435 in the leftward/rightward direction may be covered by the insertion rib 431, and an upper side of the collection space 435 may be covered by the support member 420. In other words, the collection space 435 may be defined between the cover member 430 and the support member 420.

The pair of insertion ribs 431 may extend in the forward/rearward direction. Accordingly, the collection space 435 may also extend in the forward/rearward direction. With this structure, the cooling water collected into the collection space 435 through the communication hole 425 may flow in the forward/rearward direction.

The cover member 430 may include a support plate 434 that is disposed on an inner side of the partition plate 412. The support plate 434 may support the partition plate 412. The cover member 430 may include first and second injection holes 432 and 433 that pass in the upward/downward direction.

The first injection hole 432 may serve as an opening for injecting a material (e.g., a resin) to fill the space between the partition member 410, the manifold pipe 260, the support member 420, and the cover member 430, after the partition member 410, the manifold pipe 260, the support member 420, and the cover member 430 are sequentially seated on the inner side of the side member 350.

The second injection hole 433 may serve as a discharging outlet for the injection material. It is formed on one side of the collection space 435 opposite to the first injection hole 432, through which the material is injected. In other words, the injection material injected between the partition member 410, the manifold pipe 260, the support member 420, and the cover member 430 through the first injection hole 432 may be discharged to the lower side of the cover member 430 through the second injection hole 433.

When it is identified that the injection material injected through the first injection hole 432 is discharged through the second injection hole 433, it may be determined that the space between the partition member 410, the manifold pipe 260, the support member 420, and the cover member 430 is filled with the injected material.

The space between the partition member 410, the manifold pipe 260, the support member 420, and the cover member 430 may be filled to prevent the cooling water discharged from the manifold pipe 260 from leaking the outside of the cover module 400 through any path other than the collection space 435 of the cover module 400.

The injection space 422 of the support member 420 may be formed in an area corresponding to a position of the first injection hole 432. For example, the injection space 422 and the first injection hole 432 may overlap each other in the forward/rearward direction when viewed from an upper side or a lower side.

With this structure, when the injection material is injected through the first injection hole 432, the injection material may flow more smoothly to the second injection hole 433 through the injection space 422, and through this, the injection material may fill the space between the partition member 410, the manifold pipe 260, the support member 420, and the cover member 430.

The first injection hole 432 and the second injection hole 433 may be formed in plural. The first injection holes 432 and the second injection holes 433 may be alternately arranged in the forward/rearward direction while being spaced apart from each other in the leftward/rightward direction.

As illustrated in FIG. 7, the support member 420 may include a structure for seating the manifold pipe 260. One side of the support member 420, which faces the partition member 410, may be formed to correspond to a curvature of the manifold pipe 260.

A guide groove 426 and a seating recess 427 formed in recessed shapes may be provided on one side of the support member 420, which faces the partition member 410. In other words, the guide groove 426 and the seating recess 427 may be formed on one side of the support member 420 as recessed features. The guide groove 426 and the seating recess 427 may be provided to be spaced apart from each other in the forward/rearward direction. A width of the guide groove 426 in the forward/rearward direction may be formed to greater than that of the seating recess 427.

A flow space 428 formed to be communicated with the guide groove 426 and the seating recess 427 may be provided at one side of the support member 420, which faces the partition member 410. The flow space 428 may extend in the forward/rearward direction to communicate the guide groove 426 and the communication hole 425 with each other. In other words, one side of the flow space 428 may be connected to the guide groove 426 and an opposite side thereof may be connected to the communication hole 425. The flow space 428 may be formed to be recessed on one side of the support member 420, which faces the partition member 410, to extend in the forward/rearward direction.

The manifold pipe 260 may include a pipe body 261 that extends in the forward/rearward direction to allow the cooling water to flow in an interior thereof, and a guide part 262 that protrudes from the pipe body 261 to connect the pipe body 261 and the branch pipe 270. The guide part 262 may be seated on the guide groove 426. Portions of circumferential surfaces of the guide part 262 and the guide groove 426 may be spaced apart from each other, so that the cooling water discharged from the manifold pipe 260 may flow to the flow space 428 along a circumference of the guide part 262. Thereafter, the cooling water may flow to the communication hole 425 through the flow space 428.

The manifold pipe 260 may include a protrusion 263 that protrudes from the pipe body 261 and is spaced apart from the guide part 262 in the forward/rearward direction. The protrusion 263 may be seated in the seating recess 427.

As described above, when the battery cell 200 and the pack cover (not illustrated) are mounted on the battery housing 300 (see FIG. 1), the base plate 310 (see FIG. 2) of the battery pack 100 may be mounted on the electric vehicle with being inverted in the upward/downward direction so that the base plate 310 (see FIG. 2) of the battery pack 100 is disposed on an upper side of the electric vehicle.

This is because a spatial utility may be increased in the case of a structure, in which the base plate 310 of the battery pack 100 is disposed on an upper side of the electric vehicle compared to the case, in which the base plate of the battery pack is disposed on a lower side of the electric vehicle.

This is because, in the former case, a space that may absorb an impact to protect the battery cells has to be provided on a lower side of the battery cells, and a space for a flame or gas has to be separately provided on an upper side of the battery cells, whereas in the latter case, a space that may absorb an impact and a space for a flow space, for example, for a flame or gas may be provided on the upper side of the battery cells, and thus, a spatial utility may be high in the latter case.

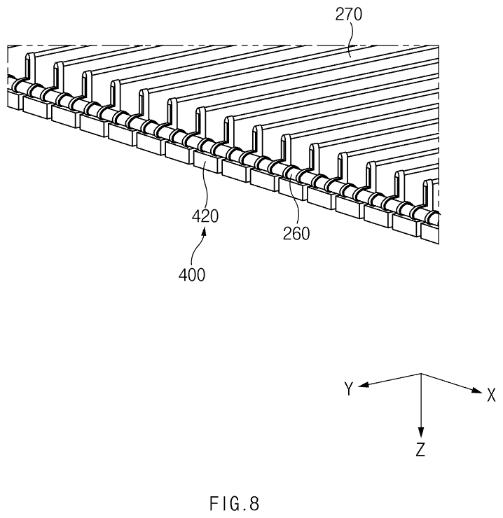

FIG. 8 is a view of a cover module and a cooling water channel according to an embodiment of the present disclosure.

Referring to FIGS. 7 and 8, under the structure, in which the battery pack 100 is mounted on the electric vehicle, as the guide part 262 is seated on the guide groove 426 and the protrusion 263 is seated on the seating recess 427, the manifold pipe 260 may be supported more stably by the support member 420.

Furthermore, even if an impact occurs on an outside of an electric vehicle equipped with the battery pack 100 in the leftward/rightward direction (see FIG. 1), the impact transmitted to the manifold pipe 260 may be relatively reduced due to the structure formed of ethylene propylene rubber (EPDM), as the support member 420 absorbs part of the impact. In other words, due to the support member 420 being formed of ethylene propylene rubber (EPDM), an impact from the lateral (left/right) side of an electric vehicle equipped with the battery pack 100 may be partially absorbed, thereby relatively reducing the impact transmitted to the manifold pipe 260.

Furthermore, the manifold pipe 260 may contact the support member 420 to prevent heat from being received from an external environment of the electric vehicle.

FIG. 9 is a schematic view of a manifold pipe with a portion thereof being omitted, and peripheral components according to an embodiment of the present disclosure. FIG. 10 is a cross-sectional view of a battery housing according to an embodiment of the present disclosure. FIG. 11 is a cross-sectional view of a battery housing according to an embodiment of the present disclosure.

Referring to FIGS. 9 to 11, in the structure where the battery pack 100 is mounted on an electric vehicle, the manifold pipe 260 may be supported by the support member 420, and the partition member 410 may be provided between the manifold pipe 260 and the base plate 310.

In this case, the cooling water discharged from a damaged portion of the manifold pipe 260, caused by an impact to the electric vehicle, may flow toward the flow space 428 by gravity, along a circumference of the guide part 262 or a circumference of the pipe body 261. The cooling water that flows to the flow space 428 may be guided to the communication hole 425 along an extension direction of the flow space 428. The cooling water guided to the communication hole 425 may flow into the collection space 435 by gravity, and may flow in the forward/rearward direction along the collection space 435.

Because the spaces between the manifold pipe 260, the partition member 410, the support member 420, and the cover member 430 are filled with the injection material, the cooling water discharged from the manifold pipe 260 may be prevented from being discharged to the outside of the cover module 400 (see FIG. 4) through a portion other than the collection space 435.

In an embodiment, a cooling water discharge pipe 440 may be provided at one end of the collection space 435. The cooling water discharge pipe 440 may include one end 441 that is inserted into the cover member 430, and an opposite end 442 that passes through the side member 350 while being communicated with the collection space 435.

With this structure, the cooling water that flows to a front side of the battery housing 300 through the collection space 435 may be discharged to the outside of the battery housing 300 through the cooling water discharge pipe 440.

As illustrated in FIG. 11, the cover member 430 may include a discharge pipe support part 436 that supports one end of the cooling water discharge pipe 440. The discharge pipe support part 436 may extend in the forward/rearward direction, and may be mounted between the pair of insertion ribs 431.

The front end of the cover member 430 may be disposed on a front side of the front end of the support member 420. This may be because the cover member 430 has to cover the manifold pipe 260 and an upper side of the introduction pipe, which is connected to the manifold pipe 260, but the support member 420 supports only the manifold pipe 260.

Under the above-described structure, a front end of the support member 420 and a front end of the insertion rib 431 may be spaced apart from each other in the forward/rearward direction. The front end of the insertion rib 431 may be disposed on a front side of the front end of the support member 420. In this case, the discharge pipe support part 436 may be formed to connect the front end of the support member 420 to the insertion rib 431.

With this structure, the cooling water collected in the collection space 435 may flow to one end of the cooling water discharge pipe 440 by the discharge pipe support part 436, and may be discharged to the outside of the battery housing 300.

The cooling water discharge pipe 440 may be formed of rubber to prevent the cooling water discharge pipe 440 from being easily damaged even when an impact is applied to the side member 350, but is not limited thereto.

According to the present disclosure, because the cover module covers an inside of the manifold pipe, the cooling water may be prevented from contacting the battery cells even through the cooling water is discharged from the manifold pipe.

In addition, according to the present disclosure, because the cooling water flows in the forward/rearward direction along the collection space and is discharged to the outside of the battery housing even through the cooling water is discharged from the manifold pipe, a stability of the battery housing may be improved.

In addition, according to the present disclosure, because the position of the cooling water channel may be guided, a manufacturing performance of the battery housing may be improved.

In addition, according to the present disclosure, the injection material is inserted into the interior of the cover module, the cooling water may be prevented from being discharged to the outside of the cover module even though the cooling water is discharged from the manifold pipe.

In addition, various effects may be provided that are directly or indirectly identified through the embodiments of the present disclosure.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery housing comprising:
a base plate;
a side member disposed on a side of the base plate in a first direction;
a cooling water channel disposed on an inner side of the side member in the first direction, wherein the cooling water channel includes a manifold pipe extending in a second direction crossing the first direction; and
a cover module covering an inner side of the manifold pipe and extending in the second direction to accommodate the manifold pipe together with the side member,
wherein the cover module includes a support member configured to support the manifold pipe.

2. The battery housing of claim 1, wherein the cover module includes:
a partition member covering the inner side of the manifold pipe in the first direction; and
a cover member disposed on a side of the support member in a third direction crossing the first direction and the second direction, wherein the cover member includes a collection space extending in the second direction on a side facing the support member.

3. The battery housing of claim 2, wherein the support member includes a communication hole extending in the third direction to be communicated with the collection space.

4. The battery housing of claim 3, wherein the support member includes a cover recess formed on a side surface of the support member, which faces the cover member, and
wherein the cover member includes a pair of insertion ribs protruding toward the cover recess and spaced apart from each other in the first direction to define the collection space therebetween.

5. The battery housing of claim 4, wherein one end of the communication hole, which is communicated with the cover recess, is disposed between the pair of insertion ribs.

6. The battery housing of claim 4, wherein the pair of insertion ribs extend in the second direction.

7. The battery housing of claim 2, wherein the partition member includes:
a plurality of fixing slots formed on the inner side of the manifold pipe in the first direction and configured to extend in the third direction; and
a plurality of partition plates spaced apart from each other in the second direction, wherein fixing slots of the plurality of fixing slots are respectively interposed between the plurality of partition plates.

8. The battery housing of claim 2, wherein the partition member includes:
a fixing hole formed on the inner side of the manifold pipe in the first direction; and
a plurality of partition plates spaced apart from each other in the second direction with the fixing hole interposed therebetween.

9. The battery housing of claim 8, wherein the partition member further includes:
a pipe cover part extending to surround an opposite side of the manifold pipe in the third direction from the plurality of partition plates to contact the side member.

10. The battery housing of claim 9, wherein the pipe cover part includes:
a first part extending from the plurality of partition plates toward the side member; and
a second part extending from the first part in the third direction to contact the side member.

11. The battery housing of claim 8, wherein the cooling water channel includes:
a branch pipe connected to the manifold pipe, and inserted into the fixing hole.

12. The battery housing of claim 11, wherein the manifold pipe includes:
a pipe body extending in the second direction, and configured to allow cooling water to flow in an interior thereof; and
a guide part connecting the pipe body and the branch pipe.

13. The battery housing of claim 12, wherein the support member includes:
a communication hole extending in the third direction to be communicated with the collection space; and
a flow space configured to communicate with the communication hole and formed to be recessed on one side of the support member, which faces the partition member, wherein the flow space extends in the second direction.

14. The battery housing of claim 12, wherein the manifold pipe further includes a protrusion protruding from the pipe body and spaced apart from the guide part in the second direction, and
wherein the support member includes a seating recess recessed to receive the protrusion.

15. The battery housing of claim 2, wherein the cover member includes:
a first injection hole through which a material is injected to fill a space between the support member, the partition member, and the manifold pipe.

16. The battery housing of claim 15, wherein the cover member further includes:
a second injection hole formed on a side of the collection space opposite to the first injection hole, and configured to discharge the material injected through the first injection hole.

17. The battery housing of claim 15, wherein the support member includes an injection space formed in an area corresponding to a position of the first injection hole.

18. The battery housing of claim 2, further comprising:
a cooling water discharge pipe configured to communicate with the collection space, and including a first end inserted into the cover member and a second end passing through the side member.

19. The battery housing of claim 18, wherein the cover member further includes:
a discharge pipe support part supporting the first end of the cooling water discharge pipe.

20. The battery housing of claim 19, wherein the support member includes a cover recess formed on a side surface of the support member, which faces the cover member, and
wherein the cover member includes a pair of insertion ribs protruding toward the cover recess and spaced apart from each other in the first direction to define the collection space therebetween,
wherein an end of the insertion rib in the second direction and an end of the cover member in the second direction are spaced apart from each other in the second direction, and
wherein the discharge pipe support part is formed to connect the end of the insertion rib and the end of the support member.
